(19) United States
(12) Patent Application Publication
(10) Pub. No.: US 2026/0142729 A1
(43) Pub. Date: May 21, 2026

(54) SIGNAL TO NOISE AND DISTORTION RATIO (SNDR) ANALYSIS FOR CHARACTERIZATION OF A LINEAR PLUGGABLE OPTICS (LPO) MODULE

(71) Applicant: Cisco Technology, Inc., San Jose, CA (US)

(72) Inventors: Fabio Bottoni, Milan (IT); Masoud Ghoreishi Madiseh, Maple Ridge (CA); Alessandro Cavaciuti, San Donato Milanese (IT); Marco Mazzini, Seville (ES); Ricardo Andres Aroca, Jersey City, NJ (US)

(21) Appl. No.: 18/953,483

(22) Filed: Nov. 20, 2024

(51) Int. Cl. H04B 10/58; G02B 6/42; H04B 10/61

(52) U.S. Cl. CPC H04B 10/58; G02B 6/4284; H04B 10/6163

(57) ABSTRACT

An approach to isolate and characterize non-linear distortion attributable, at least in part, to an LPO (Linear Pluggable Optics) module is provided. A method includes receiving, at a linear pluggable optics (LPO) module, a signal from a host, converting, by the LPO module, the signal to an optical signal, isolating nonlinear distortion of the optical signal attributable, at least in part, to the LPO module, determining a portion of the nonlinear distortion that is memoryless, processing the signal to reduce an impact of the portion of the nonlinear distortion that is memoryless and generating a processed signal as a result of the processing, and determining a signal-to-distortion ratio (SDR) level of the processed signal based on a remaining portion of the nonlinear distortion.

### TECHNICAL FIELD

The present disclosure relates to the operation and characterization of an LPO (Linear Pluggable Optics) module.

### BACKGROUND

A linear direct-drive pluggable optical module, or Linear Pluggable Optics (LPO) module, is an advanced module for optical fiber communications, aimed at simplifying the architecture, improving the performance of an optical network, and reducing power consumption. An LPO module directly converts the electrical signal into an optical signal, and then transmits the optical signal via an optical fiber to a receiving side. The receiving side converts the optical signal from the optical fiber back into an electrical signal. The “direct-drive” nature of the pluggable module refers to a design feature in which local digital signal processing is not performed onboard the module itself, thus simplifying signal processing flow and reducing delay and power consumption.

### BRIEF DESCRIPTION OF THE DRAWINGS

FIG. 1 is a block diagram of an LPO (Linear Pluggable Optics) module in communication with a host device along with non-linear distortion isolation logic, according to an example embodiment.

FIGS. 2-4 are block diagrams that illustrate one technique for isolating non-linear distortion attributable, at least in part, to the LPO module, according to an example embodiment.

FIGS. 5 and 6 are block diagrams that illustrate another technique for isolating non-linear distortion attributable, at least in part, to the LPO module, according to an example embodiment.

FIGS. 7 and 8 are block diagrams that illustrate yet another technique for isolating non-linear distortion attributable, at least in part, to the LPO module, according to an example embodiment.

FIG. 9 is a flowchart depicting a series of operations to isolate and characterize non-linear distortion attributable, at least in part, by the LPO module, according to an example embodiment.

FIG. 10 is a block diagram of a computing device that may be configured to host non-linear distortion isolation logic, and to perform techniques described herein, according to an example embodiment.

### DETAILED DESCRIPTION

### Overview

An approach to isolate and characterize non-linear distortion attributable, at least in part to an LPO (Linear Pluggable Optics) module is provided. A method includes receiving, at a linear pluggable optics (LPO) module, a signal from a host, converting, by the LPO module, the signal to an optical signal, isolating nonlinear distortion of the optical signal attributable, at least in part, to the LPO module, determining a portion of the nonlinear distortion that is memoryless, processing the signal to reduce an impact of the portion of the nonlinear distortion that is memoryless and generating a processed signal as a result of the processing, and determining a signal-to-distortion ratio (SDR) level of the processed signal based on a remaining portion of the nonlinear distortion.

An apparatus is also described and includes an interface configured to enable network communications, a memory, and one or more processors coupled to the interface and the memory, and configured to: receive, at a linear pluggable optics (LPO) module, a signal from a host, convert, by the LPO module, the signal to an optical signal, isolate nonlinear distortion of the optical signal attributable, at least in part, to the LPO module, determine a portion of the nonlinear distortion that is memoryless, process the signal to reduce an impact of the portion of the nonlinear distortion that is memoryless and to generate a processed signal, and determine a signal-to-distortion ratio (SDR) level of the processed signal based on a remaining portion of the nonlinear distortion.

### EXAMPLE EMBODIMENTS

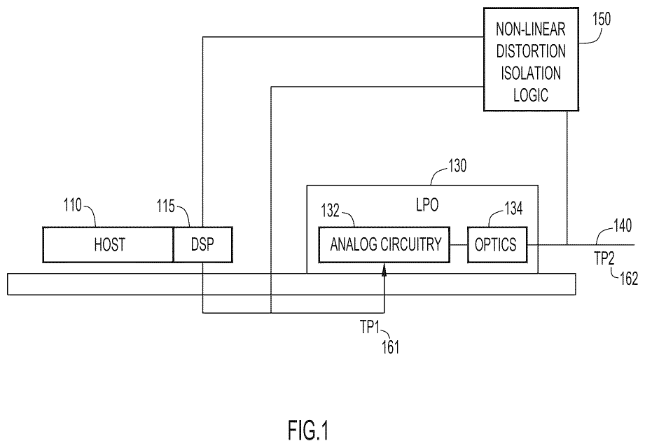

FIG. 1 is a block diagram of a Linear Pluggable Optics module, or LPO module 130, in communication with a host device along with non-linear distortion isolation logic 150, according to an example embodiment. As shown, a host 110, such as a network switch, includes a digital signal processor, or DSP 115. An output of host 110, in the form of an electrical signal generated by DSP 115, is supplied to LPO module 130, which includes analog circuitry 132 and an optics section 134, which together are configured to convert the electrical signal supplied by the host 110 into an optical signal that is launched into a connected optical fiber 140. Non-linear distortion isolation logic 150, as will be explained below, is configured to monitor operational and/or performance aspects of host 110 and the generated optical signal to characterize the operation and/or performance of LPO module 130, and to, as needed, apply one or more corrective actions, by appropriately controlling or instructing DSP 115, to improve the performance of LPO module 130, or the optical output of LPO module 130. Non-linear distortion isolation logic 150 may include both hardware and software components.

Also shown in FIG. 1 are TP1 161 (test point 1) and TP2 162 (test point 2) that are monitored by non-linear distortion isolation logic 150. Details concerning this functionality are provided below. Data, feedback, and/or control signals may be supplied to/by non-linear distortion isolation logic 150 by/to host 110, and particularly to DSP 115, to implement pre-emphasis, equalization, and/or other techniques to decrease or eliminate noise and distortion detected in the optical signal generated by LPO module 130.

Signal-to-Noise and Distortion Ratio (SNDR) is a metric used to assess the performance of a high-speed communication link by quantifying the level of a desired signal relative to the combined levels of unwanted noise and non-linear distortion.

SNDR may be calculated with the following formula:

$$SNDR = 10 {log}_{10} ( {{P}_{max}}^{2} / ( {{σ}_{e}}^{2} + {{σ}_{n}}^{2} ) )$$

In the above formula,
Pₘₐₓ is the peak of the pulse response;
σₑ is essentially the distortion from a linear response; and
σₙ is essentially all other external noise.

The embodiments described herein are configured to isolate non-linear distortion to better qualify the performance of the LPO module 130. In other words, the described techniques are configured to better quantify

$${σ}_{e}^{2} ( or SDR = 10 {log}_{10} ( {P}_{max}^{2} / {σ}_{e}^{2} ) )$$

and identify the portion that is memoryless (i.e., the portion that can be corrected by DSP 115 using, e.g., Ratio Level Mismatch (RLM) correction) compared to the portion that is memory-based and, effectively, uncorrectable (unless a more elaborate, and power consuming, DSP 115 is used).

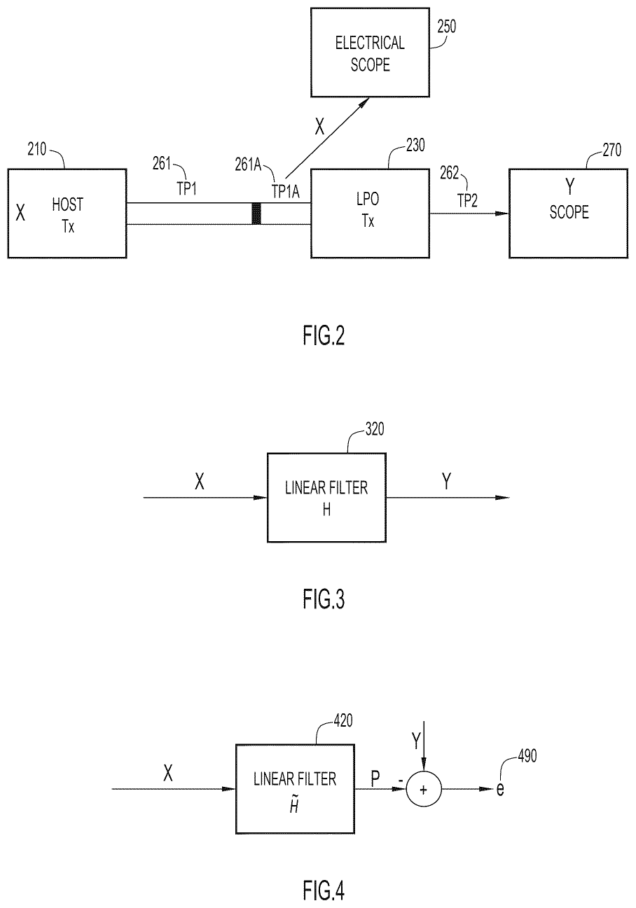

FIGS. 2-4 are block diagrams that illustrate one technique for isolating non-linear distortion attributable, at least in part, to an LPO module 230, according to an example embodiment. Components shown in FIGS. 2-4 may be included in, or operate in connection with, non-linear distortion isolation logic 150 shown in FIG. 1. In the embodiment of FIG. 2, host 210 (such as a network switch) transmits an electrical digital pattern X (such as a pseudorandom binary sequence (PRBS)) to LPO module 230. Test point TP1 261 and test point TP1A 261A are available to monitor the transmitted digital pattern X. LPO module 230 receives the digital pattern X and converts the same into an optical signal Y that can be monitored at test point TP2 262. In this case, an optical scope 270 monitors the optical signal Y output by LPO module 230. An electrical scope 250 monitors the transmitted pattern X at TP1A 261A

In accordance with an embodiment, a linear filter H 320 is trained with output Y (measured at TP2 262) given input X. For example, the transmitted PRBS pattern X may be passed through a least mean square optimization to obtain \tilde{H}. The filter length may be set at L≤Len(PRBS)/64.

Then, as shown in FIG. 4, the transmitted PRBS pattern X is passed through (trained) linear filter \tilde{H} 420, which outputs signal P, which is subtracted from a signal representative of optical signal Y to obtain an error e 490, which contains substantially only non-linear error components. That is, given the application of linear filter \tilde{H} 420, error e 490 is comprised primarily of non-linear distortion.

More specifically, error e 490 is comprised of several components as follows: e=d+r+n_{T}+n_{R}, where
d: nonlinearity (both Host 210 and LPO module 230);
r: residual Inter Symbol Interference (ISI) (that is not tracked by \tilde{H});
n_{T}: Tx Noise (both Host 210 and LPO module 230); and
n_{R}: noise from optical scope 270.

Assuming:
r power is negligible versus other error sources,
n_{R} has a zero mean Gaussian distribution with σₙ_{_{R}} standard deviation, and
e has Gaussian distribution with σₑ standard deviation,
then the SNDR at TP2 262 is

$$SNDR = 10 \times {log}_{10} ( \frac{\overline{{Y}^{2}}}{{σ}_{e}^{2} - {σ}_{{n}_{R}}^{2}} ) .$$

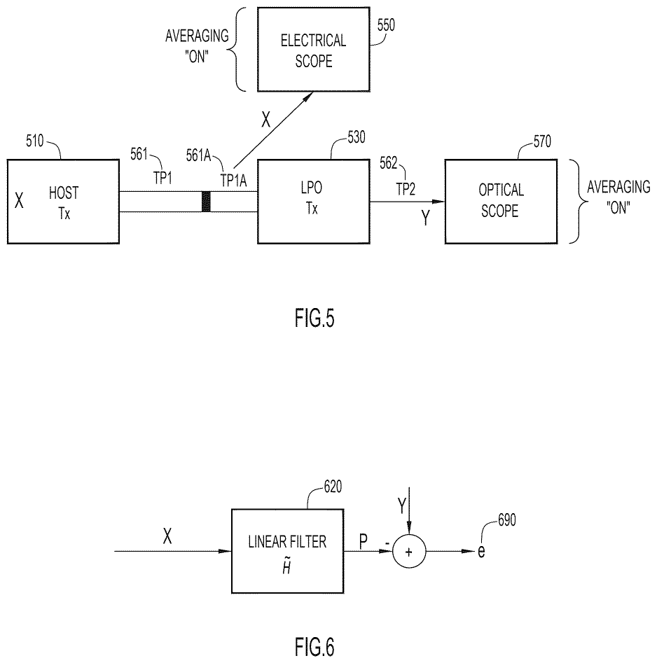

FIGS. 5 and 6 are block diagrams that illustrate another technique for isolating non-linear distortion caused by an LPO module 530, according to an example embodiment. In the embodiment of FIG. 5, host 510 (such as a switch) transmits a digital pattern X (such as a pseudorandom binary sequence (PRBS)) to LPO module 530. Test point TP1 561 and test point TP1A 561A are available to monitor the transmitted digital pattern X. LPO module 530 receives the digital pattern X and converts the same into an optical signal Y that can be monitored at test point TP2 562. In this case, an optical scope 570 monitors the optical signal Y output by LPO module 530. An electrical scope 550 monitors the transmitted pattern X at TP1A 561A. In this embodiment, both the electrical scope 550 and optical scope 570 are configured to average the monitored signals, e.g., over 64 samples.

In accordance with an embodiment, a linear filter H is trained with output Y (measured at TP2 562) given input X. For example, the transmitted PRBS pattern X may be passed through a least mean square optimization to obtain \tilde{H}. The filter length may be set at L≤Len(PRBS)/64.

Then, as shown in FIG. 6, the transmitted PRBS pattern X is passed through trained linear filter \tilde{H} 620, which outputs signal P, which is subtracted from a signal representative of optical signal Y to obtain an error e 690, which contains substantially only non-linear error components.

Specifically, error e 690 is comprised of several components as follows: e=d+r+n_{T}+n_{R}, where
d: nonlinearity (LPO module 530);
r: residual Inter Symbol Interference (ISI) (that is not tracked by H);
n_{T}: Tx Noise (LPO module 530); and
n_{R}: noise from optical scope 570.

Assuming:
r power is negligible compared versus other error sources,
n_{R} power, after averaging, is negligible compared to power of d,
n_{T} power, after averaging, is negligible compared to power of d, and
d has Gaussian distribution with σ_{d} standard deviation,
then the SDR (signal-to-distortion ratio) at

$$TP 2 \; 562 is SDR = 10 \times {log}_{10} ( \frac{\overline{{Y}^{2}}}{{σ}_{d}^{2}} ) .$$

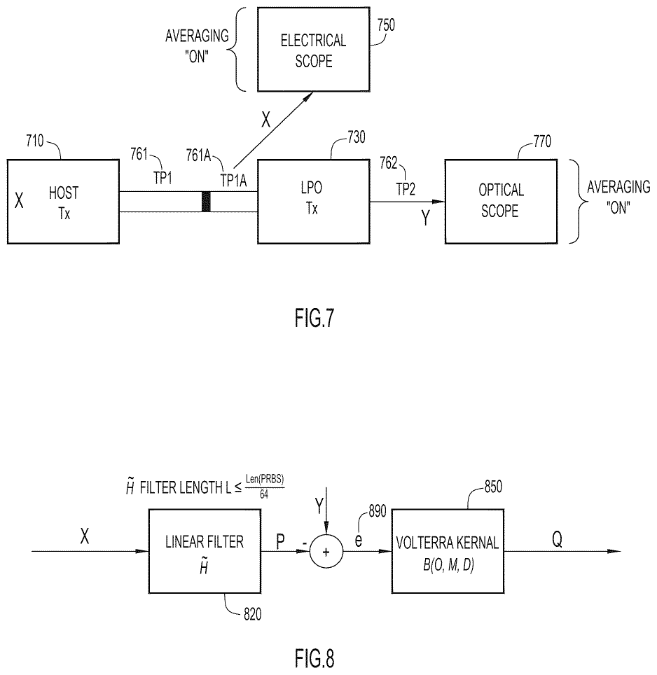

FIGS. 7 and 8 are block diagrams that illustrate still another technique for isolating non-linear distortion caused by an LPO module 730, according to an example embodiment. In the embodiment of FIG. 7, host 710 (such as a switch) transmits a digital pattern X (such as a pseudorandom binary sequence (PRBS)) to LPO module 730. Test point TP1 761 and test point TP1A 761A are available to monitor the transmitted digital pattern X. LPO module 730 receives the digital pattern X and converts the same into an optical signal Y that can be monitored at test point TP2 762. In this case, an optical scope 770 monitors the optical signal Y output by LPO module 730. An electrical scope 750 monitors the transmitted pattern X at TP1A 761A. In this embodiment, both the electrical scope 750 and optical scope 770 are configured to average the monitored signals, e.g., over 64 samples.

In accordance with an embodiment, a linear filter H is trained with output Y (measured at TP2 762) given input X. For example, the transmitted PRBS pattern X may be passed through a least mean square optimization to obtain \tilde{H}. The filter length may be set at L≤Len(PRBS)/64.

Then, as shown in FIG. 8, the transmitted PRBS pattern X is passed through trained linear filter \tilde{H} 820, which outputs signal P, which is subtracted from a signal representative of optical signal Y to obtain an error e 890, which contains substantially only non-linear error components. Error e 890 is fed to a Volterra Kernel 850, which outputs a value Q.

More specifically, a Volterra Kernel B(O, M, D) of order O, memory length M, and with diagonal terms D is fit to error e 890 as e=Y−P. This approach helps to capture, or model, memory-based impacts of the non-linear distortion.

Error e 890 is comprised of several components as follows: e=d+r+n_{T}+n_{R}
d: nonlinearity (LPO module 730);
r: residual Inter Symbol Interference (ISI) (that is not tracked by \tilde{H});
n_{T}: Tx Noise (LPO module 730); and
n_{R}: noise from optical scope 770.

Further, the term P−Y−Q represents kernel and other residual errors (r, n_{T}, n_{R}).

Assuming:

$${SNDR}_{1} = 10 \times {log}_{10} ( \frac{\overline{{Y}^{2}}}{{σ}_{e}} ) , and$$

$${SNR}_{2} = 10 \times {log}_{10} ( \frac{\overline{{Y}^{2}}}{\overline{{( P - Y - Q )}^{2}}} )$$

$$then \frac{1}{SDR} = \frac{1}{{SNDR}_{1}} - \frac{1}{{SNR}_{2}} ( via RMS subtraction ) .$$

The above SDR value thus represents the memory-based non-linear distortion that is associated with, or attributable to, LPO module 730. In this way, the performance of LPO module 730 may be characterized.

Those skilled in the art will appreciate that non-linear distortion isolation logic 150, illustrated in FIG. 1, is also configured to operate in connection with the embodiments depicted in FIGS. 2-8. In this regard, after isolating the non-linear distortion and, further characterizing the non-linear distortion attributable to memory-based non-linear distortion, non-linear distortion isolation logic 150 may be further configured to apply or cause a corrective signal processing technique to be performed, e.g., via DSP 115 in host 110 (or 210, 510, 710) to improve the SDR of LPO module 130 (or 230, 530, 730). For example, non-linear distortion isolation logic 150 may cause, control, or direct, DSP 115 to adjust equalization levels, to adjust gain or level, and/or to perform pre-emphasis operations on the electrical signal supplied to LPO module 130 (or 230, 530, 730). In this way, it may be possible to reduce difficult-to-correct memory-based non-linear distortion attributable to LPO module 130 (or 230, 530, 730).

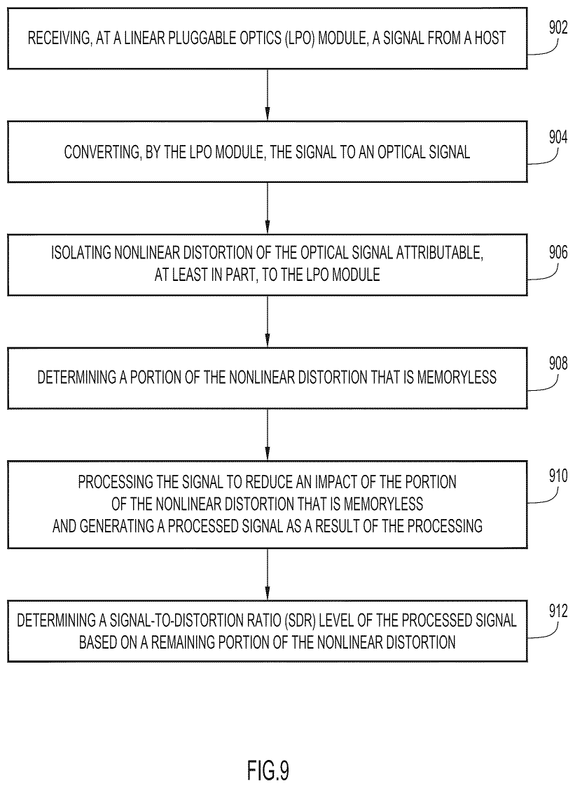

FIG. 9 is a flowchart depicting a series of operations of a method to isolate and characterize non-linear distortion attributable, at least in part, to an LPO module, according to an example embodiment. As shown, at 902, an operation includes receiving, at a linear pluggable optics (LPO) module, a signal from a host. At 904, an operation includes converting, by the LPO module, the signal to an optical signal. At 906, an operation includes isolating nonlinear distortion of the optical signal attributable, at least in part, to the LPO module. At 908, an operation includes determining a portion of the nonlinear distortion that is memoryless. At 910, an operation includes processing the signal to reduce an impact of the portion of the nonlinear distortion that is memoryless and generating a processed signal as a result of the processing. And, at 912, an operation includes determining a signal-to-distortion ratio (SDR) level of the processed signal based on a remaining portion of the nonlinear distortion.

As explained above, Linear Pluggable Optics is a technology increasingly common in high-speed data communications, particularly for applications that rely on lower overall power consumption while maintaining the flexibility of optical pluggable devices. The embodiment described herein provide an approach to effectively define the quality of a linear optical transmitter, particularly in connection with non-linear distortion. That is, according to the disclosed embodiments, non-linear distortion isolation logic is configured to isolate the nonlinearity distortion that is memoryless (and can be corrected by DSP RLM correction) compared to the portion (memory-based distortion) that may be uncorrectable (unless a more complicated DSP is used along with such a devices attendant increased power consumption).

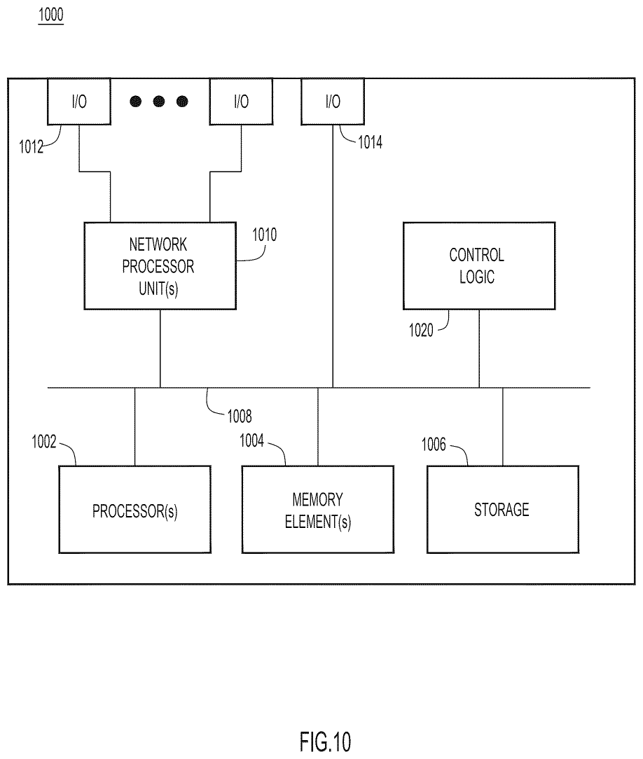

FIG. 10 is a block diagram of a computing device that may be configured to host non-linear distortion isolation logic, and to perform techniques described herein, according to an example embodiment. In various embodiments, a computing device, such as computing device 1000 or any combination of computing devices 1000, may be configured as any entity/entities as discussed for the techniques depicted in connection with FIGS. 1-9 in order to perform operations of the various techniques discussed herein.

In at least one embodiment, the computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with memory element(s) 1004 (or vice versa) or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 (wired and/or wireless) to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include receiving, at a linear pluggable optics (LPO) module, a signal from a host, converting, by the LPO module, the signal to an optical signal, isolating nonlinear distortion of the optical signal attributable, at least in part, to the LPO module, determining a portion of the nonlinear distortion that is memoryless, processing the signal to reduce an impact of the portion of the nonlinear distortion that is memoryless and generating a processed signal as a result of the processing, and determining a signal-to-distortion ratio (SDR) level of the processed signal based on a remaining portion of the nonlinear distortion.

In the method, the remaining portion of the nonlinear distortion may be substantially memory-based nonlinear distortion.

The method may further include characterizing a performance of the LPO module based on the SDR level.

In the method, isolating the nonlinear distortion of the signal may include passing the signal through a previously trained linear distortion filter.

In the method, the processing may include applying, using a digital signal processor in the host, ratio level mismatch (RLM) correction to the signal.

The method may further include controlling, based on the SDR level, a digital signal processor in the host to increase the SDR level.

The method may further include using the digital signal processor, modifying a gain of the signal.

The method may further include using the digital signal processor, modifying an equalization level of the signal.

The method may further include fitting a Volterra Kernel to the remaining portion of the nonlinear distortion.

In the method, the signal may include a pseudorandom binary sequence.

In another embodiment, a device may be provided and may include an interface configured to enable network communications, a memory, and one or more processors coupled to the interface and the memory, and configured to: receive, at a linear pluggable optics (LPO) module, a signal from a host, convert, by the LPO module, the signal to an optical signal, isolate nonlinear distortion of the optical signal attributable, at least in part, to the LPO module, determine a portion of the nonlinear distortion that is memoryless, process the signal to reduce an impact of the portion of the nonlinear distortion that is memoryless and to generate a processed signal, and determine a signal-to-distortion ratio (SDR) level of the processed signal based on a remaining portion of the nonlinear distortion.

In the apparatus, the remaining portion of the nonlinear distortion may be substantially memory-based nonlinear distortion.

In the apparatus, the one or more processors may be configured to characterize a performance of the LPO module based on the SDR level.

In the apparatus, the one or more processors may be configured to isolate the nonlinear distortion of the signal by passing the signal through a previously trained linear distortion filter.

In the apparatus, the one or more processors may be configured to process the signal by applying, using a digital signal processor in the host, ratio level mismatch (RLM) correction to the signal.

In the apparatus, the one or more processors may be configured to control, based on the SDR level, a digital signal processor in the host to increase the SDR level by at least one of modifying a gain of the signal and modifying an equalization level of the signal.

In yet another embodiment, one or more non-transitory computer readable storage media encoded with instructions are provided and that, when executed by a processor, cause the processor to: convert a signal, obtained at a linear pluggable optics (LPO) module from a host, to an optical signal, isolate nonlinear distortion of the optical signal attributable, at least in part, to the LPO module, determine a portion of the nonlinear distortion that is memoryless, process the signal to reduce an impact of the portion of the nonlinear distortion that is memoryless and to generate a processed signal, and determine a signal-to-distortion ratio (SDR) level of the processed signal based on a remaining portion of the nonlinear distortion.

In an embodiment, the remaining portion of the nonlinear distortion may be substantially memory-based nonlinear distortion.

In an embodiment, the instructions may be configured to cause the processor to characterize a performance of the LPO module based on the SDR level.

In an embodiment, the instructions may be configured to cause the processor to isolate the nonlinear distortion of the signal by passing the signal through a previously trained linear distortion filter.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving, at a linear pluggable optics (LPO) module, a signal from a host;
converting, by the LPO module, the signal to an optical signal;
isolating nonlinear distortion of the optical signal attributable, at least in part, to the LPO module;
determining a portion of the nonlinear distortion that is memoryless;
processing the signal to reduce an impact of the portion of the nonlinear distortion that is memoryless and generating a processed signal as a result of the processing; and
determining a signal-to-distortion ratio (SDR) level of the processed signal based on a remaining portion of the nonlinear distortion.

2. The method of claim 1, wherein the remaining portion of the nonlinear distortion is substantially memory-based nonlinear distortion.

3. The method of claim 1, further comprising characterizing a performance of the LPO module based on the SDR level.

4. The method of claim 1, wherein isolating the nonlinear distortion of the signal comprises passing the signal through a previously trained linear distortion filter.

5. The method of claim 1, wherein the processing comprises applying, using a digital signal processor in the host, ratio level mismatch (RLM) correction to the signal.

6. The method of claim 1, further comprising controlling, based on the SDR level, a digital signal processor in the host to increase the SDR level.

7. The method of claim 6, further comprising, using the digital signal processor, modifying a gain of the signal.

8. The method of claim 6, further comprising, using the digital signal processor, modifying an equalization level of the signal.

9. The method of claim 1, further comprising fitting a Volterra Kernel to the remaining portion of the nonlinear distortion.

10. The method of claim 1, wherein the signal comprises a pseudorandom binary sequence.

11. An apparatus comprising:
an interface configured to enable network communications;
a memory; and
one or more processors coupled to the interface and the memory, and configured to:
receive, at a linear pluggable optics (LPO) module, a signal from a host;
convert, by the LPO module, the signal to an optical signal;
isolate nonlinear distortion of the optical signal attributable, at least in part, to the LPO module;
determine a portion of the nonlinear distortion that is memoryless;
process the signal to reduce an impact of the portion of the nonlinear distortion that is memoryless and to generate a processed signal; and
determine a signal-to-distortion ratio (SDR) level of the processed signal based on a remaining portion of the nonlinear distortion.

12. The apparatus of claim 11, wherein the remaining portion of the nonlinear distortion is substantially memory-based nonlinear distortion.

13. The apparatus of claim 11, wherein the one or more processors are configured to characterize a performance of the LPO module based on the SDR level.

14. The apparatus of claim 11, wherein the one or more processors are configured to isolate the nonlinear distortion of the signal by passing the signal through a previously trained linear distortion filter.

15. The apparatus of claim 11, wherein the one or more processors are configured to process the signal by applying, using a digital signal processor in the host, ratio level mismatch (RLM) correction to the signal.

16. The apparatus of claim 11, wherein the one or more processors are configured to control, based on the SDR level, a digital signal processor in the host to increase the SDR level by at least one of modifying a gain of the signal and modifying an equalization level of the signal.

17. One or more non-transitory computer readable storage media encoded with instructions that, when executed by a processor, cause the processor to:
convert a signal, obtained at a linear pluggable optics (LPO) module from a host, to an optical signal;
isolate nonlinear distortion of the optical signal attributable, at least in part, to the LPO module;
determine a portion of the nonlinear distortion that is memoryless;
process the signal to reduce an impact of the portion of the nonlinear distortion that is memoryless and to generate a processed signal; and
determine a signal-to-distortion ratio (SDR) level of the processed signal based on a remaining portion of the nonlinear distortion.

18. The one or more non-transitory computer readable storage media of claim 17, wherein the remaining portion of the nonlinear distortion is substantially memory-based nonlinear distortion.

19. The one or more non-transitory computer readable storage media of claim 17, wherein the instructions further cause the processor to characterize a performance of the LPO module based on the SDR level.

20. The one or more non-transitory computer readable storage media of claim 17, wherein the instructions cause the processor to isolate the nonlinear distortion of the signal by passing the signal through a previously trained linear distortion filter.
